(19) United States
(12) Patent Application Publication
(10) Pub. No.: US 2026/0307665 A1
(43) Pub. Date: Oct. 8, 2026

(54) METHOD OF ENHANCING VEHICLE SAFETY, METHOD OF CONTROLLING VEHICLE OPERATION, PROCESSING SYSTEM, VEHICLE, AND MACHINE-READABLE INSTRUCTION CODE

(71) Applicant: TomTom International B.V., Amsterdam (NL)

(72) Inventors: Vishwanath Nagnath PAI, Eindhoven (NL); Ahmad ADEE, Den Bosch (NL); Milad HASANVAND, Beek en Donk (NL)

(21) Appl. No.: 19/483,518

(22) PCT Filed: Jun. 30, 2023
(86) PCT No.: PCT/EP2023/068015

§ 371 Date: Nov. 11, 2025

(51) Int. Cl. B60W 50/00; B60W 60/00; G01C 21/00; G05B 23/02

(52) U.S. Cl. CPC B60W 50/0098; B60W 60/0015; G01C 21/3859; G05B 23/0248

(57) ABSTRACT

To enhance safety of a vehicle (10) performing an automated driving function, at least one processing circuit (20, 30) determines one or several map feature(s) and one or several key performance indicator(s) that, if not present in map data (22), can lead to a map data induced malfunction of the automated driving function. The map data (22) is verified to comply with criteria that depend on the determined one or several map feature(s) and key performance indicator(s).

### TECHNICAL FIELD

Embodiments of the invention relate to techniques associated with automated driving functions of vehicles. Embodiments of the invention relate in particular to methods and systems operative to enhance safety of automated driving functions when a vehicle uses electronic map data, optionally in combination with sensor data, to perform automated driving functions, such as driver assistance, advanced driver assistance, or autonomous driving. Embodiments of the invention also relate to processing systems, vehicles, and machine-readable instruction code associated with techniques of enhancing safety of an automated driving function.

### BACKGROUND

Techniques that provide assistance to a driver of a vehicle and/or that autonomously perform vehicle control operations are gaining popularity. In addition to enhanced convenience for a driver, or the potential of alleviating human vehicle occupants from most control operations, such techniques have the potential of eliminating human errors that can cost lives. Such techniques include, without limitation, driver assistance systems, advanced driver assistance systems (ADAS), Highly Automated Driving (HAD) systems, and/or autonomous driving systems.

Such techniques are collectively referred to as providing automated driving functions, or driving automation, at level 1 (driver assistance), level 2 (partial driving automation), level 3 (conditional driving automation), level 4 (high driving automation), or level 5 (full driving automation).

Automated driving functions may use perception, i.e., the processing and interpretation of data captured by a vehicle sensor for performing the respective automated driving function. A world model used in performing the automated driving function may be based on map data of an electronic map.

There exist a wide variety of different electronic maps which may have different levels of detail and that may differ from each other in other aspects. For illustration, the different electronic maps may be distinguished from each other by the map features of the electronic maps and the key performance indicators that the map features have in each of the electronic maps. The question of which electronic map data allows an automated driving function to be executed is, thus, pertinent to vehicle safety when executing the automated driving function.

WO 2021/170718A2 discloses a technique for the generating and provision of digital map data that is safe and reliable. The technique enables the verification of the digital map data in a map-client using a simple and efficient data structure to check the correctness of the map data before in-vehicle delivery to components that rely on this map data.

There is a need in the art for enhanced techniques of determining whether electronic map data are suitable for safe execution of an automated driving function and of taking appropriate action to ensure that an automated function executed by a vehicle is not compromised by the use of electronic map data that does not guarantee the automated function to be executed safely.

### SUMMARY

It is an object of embodiments of the invention to provide methods, systems, and devices that provide or utilize enhanced techniques of determining whether electronic map data allows an automated driving function to be performed in a safe manner.

According to embodiments of the invention, a method, a processing system, a vehicle, and machine-readable instruction code as recited in the independent claims are provided. The dependent claims define preferred and advantageous embodiments.

According to embodiments, it is determined, for each of one or several automated driving functions, which map features and which key performance indicators (KPIs) electronic map data must have to ensure that the automated driving function(s) is/are performed in a safe manner. The determined lists of map features and their KPIs required for safe execution of an automated function may then be used to verify that electronic map data to be used has the required map feature(s) and KPI(s) and/or to selectively activate or deactivate automated driving functions in a manner which ensures that all activated automated driving functions require only map feature(s) and KPI(s) that have been verified to be present in the electronic map data used for execution of the activated automated driving functions.

According to an aspect of the invention, a method of enhancing vehicle safety is provided. The method comprises determining, by at least one processing circuit, one or several safety-relevant map features and one or several safety-relevant key performance indicators (KPIs) of at least one of the one or several safety-relevant map features for an electronic map. The one or several safety-relevant map features and the one or several safety-relevant KPIs are causal for safe execution of an automated driving function by a vehicle. Determining the one or several safety-relevant map features and the one or several safety-relevant KPIs by the at least one processing circuit comprises: identifying one or several map features that affect execution of the automated driving function; determining the one or several safety-relevant map features, comprising determining which of the identified one or several map features are causal for at least one malfunction of the automated driving function; establishing, for each of the one or several safety-relevant map features, one or several KPIs of the safety-relevant map feature causal for at least one malfunction of the automated driving function; and determining the one or several safety-relevant KPIs for the one or several safety-relevant map features based at least on the established KPIs causal for the at least one malfunction. The method further comprises ensuring, by a server system or by the vehicle, compliance of electronic map data to be used in the execution of the automated driving function with criteria that are based at least on the one or several safety-relevant map features and the one or several safety-relevant KPIs of the one or several safety-relevant map features.

Various effects and advantages are associated with the method. By determining both which map feature(s) electronic map data must have for safe execution of an automated function and which KPIs are required, appropriate measures can be taken that ensure that electronic map data to be used for performing an automated driving function has both the map features and the KPIs that are required for the automated driving function to be performed in a safe manner.

The criteria with which the map data has to comply may comprise a first criterion that is based on the one or several safety-relevant map features and a second criterion that is based on the one or several safety-relevant KPIs.

Thereby, both the presence or absence of the safety-relevant map features and the presence or absence of the safety-relevant KPIs may be checked when assessing whether electronic map data complies with criteria that allow it to be used for safe execution of the automated driving function.

The criteria may comprise determining whether the electronic map data has all of the safety-relevant map features and all of the safety-relevant KPIs.

Thereby, both the presence or absence of the safety-relevant map features and the presence or absence of the safety-relevant KPIs may be checked when assessing whether electronic map data complies with criteria that allow it to be used for safe execution of the automated driving function.

The criteria may comprise determining whether at least one score that depends on the safety-relevant map features, the safety-relevant KPIs, and the map features and KPIs present in the electronic map data fulfills a threshold test.

Thereby, more complex techniques such as weighting may be used as a tool determine whether the electronic map data has map features and associated KPIs that allow the electronic map data to be used for safe execution of the automated driving function.

Establishing the one or several KPIs causal for at least one malfunction may comprise performing a causality analysis.

Thereby, those KPIs of a map feature that are causally related to at least one malfunction can be identified. The risk of electronic map data being incorrectly considered as unsuitable for performance of the automated driving function is mitigated.

The causality analysis may comprise a fault tree analysis, a Bayesian network analysis, and/or other causality analysis techniques.

Thereby, those KPIs of a map feature that are causally related to at least one malfunction can be identified.

The causality analysis may be performed based on a system model of an automated driving system (ADS), taking into consideration whether and, if so, which sensor data is used in combination with the electronic map data to determine a world model for performing the automated driving function.

Thereby, the KPIs of a map feature that are causally related to at least one malfunction can be identified even when no detailed implementation knowledge of the automated driving function is available.

The causality analysis may be performed without using information on how the sensor data and the electronic map data are fused by the ADS when performing the automated driving function.

Thereby, the KPIs of a map feature that are causally related to at least one malfunction can be identified even when no detailed implementation knowledge of the automated driving function is available.

The automated driving function may be performed based at least on sensor data and the electronic map data, wherein the causality analysis is performed under an assumption of fault-free sensor data.

Thereby, those KPIs that are causal for fault-free execution of the automated driving function may be identified in an efficient manner.

Determining which of the identified one or several map features are causal for at least one malfunction may comprise performing a further causality analysis.

Thereby, the map feature(s) that are causally related to at least one malfunction can be identified. The risk of electronic map data being incorrectly considered as unsuitable for performance of the automated driving function is mitigated.

The further causality analysis may comprise a further fault tree analysis, a further Bayesian network analysis, and/or other further causality analysis techniques.

Thereby, the map feature(s) that are causally related to at least one malfunction can be identified.

The further causality analysis may be performed based on a system model of an automated driving system (ADS), taking into consideration whether and, if so, which sensor data is used in combination with the electronic map data to determine a world model for performing the automated driving function.

Thereby, the map feature(s) that are causally related to at least one malfunction can be identified even when no detailed implementation knowledge of the automated driving function is available.

The further causality analysis may be performed without using information on how the sensor data and the electronic map data are fused by the ADS when performing the automated driving function.

Thereby, the map feature(s) that are causally related to at least one malfunction can be identified even when no detailed implementation knowledge of the automated driving function is available.

The automated driving function may be performed based at least on sensor data and the electronic map data, wherein the further causality analysis is performed under an assumption of fault-free sensor data.

Thereby, the map feature(s) causal for fault-free execution of the automated driving function may be identified in an efficient manner.

Each of the one or several safety-relevant KPIs may have an associated weight. The criteria may further be based on the weight associated with at least one of the one or several safety-relevant KPIs.

Thereby, the importance of different KPIs and/or different malfunctions may be taken into consideration when determining the suitability or unsuitability of electronic map data for performing the automated driving function.

The method may further comprise controlling at least one human machine interface (HMI) to enable the inputting of the weights.

Thereby, the weights that reflect the importance of different KPIs and/or different malfunctions may be readily input for determining the suitability or unsuitability of electronic map data for performing the automated driving function.

Determining the one or several safety-relevant KPIs based at least on the established KPIs causal for the at least one malfunction may comprise selecting the one or several safety-relevant KPIs from a pre-defined KPI set.

Thereby, the safety-relevant KPIs may be selected from a given, pre-defined set of KPIs that may be of relevance for ensuring that the electronic map data does not prejudice safe execution of the automated driving function.

The pre-defined KPI set may comprise a set of standardized KPIs for map data.

Thereby, the safety-relevant KPIs may be selected from a standardized set of KPIs agreed upon to be of potential relevance to automated driving.

The pre-defined KPI set may comprise or consist of KPIs in accordance with, or compatible with, ISO 19157:2013.

Thereby, the safety-relevant KPIs may be selected from a KPI set comprising, or consisting of, KPIs that are of most relevance to automated driving functions.

The pre-defined KPI set may comprise or consist of any one or any combination of accuracy, freshness, coverage, completeness, confidence of map data.

Thereby, the safety-relevant KPIs may be selected from a KPI set comprising, or consisting of, KPIs that are of most relevance to automated driving functions.

Ensuring compliance of the electronic map data with criteria that are based at least on the one or several safety-relevant KPIs may comprise a verification that the electronic map data have the one or several safety-relevant map features and the one or several safety-relevant KPIs.

Thereby, the electronic map data may be verified against the previously determined safety-relevant KPIs to ensure that the electronic map data is used for automated driving functions only if it has the determined safety-relevant KPIs or otherwise complies with criteria that are based at least on the determined safety-relevant KPIs.

The method may further comprise selectively executing the automated driving function by the vehicle based on a result of the verification.

Thereby, execution of the automated driving function may be restricted or modified in case the electronic map data cannot be verified to comply with the criteria. Vehicle safety is enhanced thereby.

The method may further comprise preventing execution of the automated driving function if the electronic map data does not have the one or several safety-relevant map features and preventing execution of the automated driving function if the electronic map data does not have the one or several safety-relevant KPIs.

Thereby, execution of the automated driving function is prevented in case the electronic map data cannot be verified to comply with the criteria. Vehicle safety is enhanced thereby.

The method may further comprise modifying the electronic map data, in response to detecting that the electronic map data does not comply with the criteria, such that the modified electronic map data complies with the criteria. The method may further comprise causing the modified electronic map data to be used for performing the automated driving function.

Thereby, vehicle safety is enhanced further.

The modification may be performed by a map data server system. Causing the modified electronic map data to be used may comprise transmitting the modified electronic map data from the map data server system to the vehicle. The transmission may be performed over the air (OTA).

Thereby, vehicle safety is enhanced further.

Modifying the electronic map data may comprise merging or otherwise supplementing a first electronic map that comprises the electronic map data with at least one second electronic map having KPIs different from the first electronic map.

Thereby, the electronic map data may be improved, in view of the determined safety-relevant map features and KPIs, prior to its use based on the determined safety-relevant map features and the determined safety-relevant KPIs, so as to ensure safe execution of the automated driving function. This further enhances vehicle safety.

The automated driving function may comprise or may be an automated driving function at any one of driving automation levels 1, 2, 3, 4, or 5. The automated driving function may comprise or may be an automated driving function that provides driver assistance or an automated driving function that provides enhanced driver assistance or an automated driving function that provides autonomous driving functionality.

Thereby, the systematic determination of safety-relevant map features and safety-relevant KPIs may be employed for both driver assistance and autonomous driving, which involve different degrees of automation. This further enhances vehicle safety.

The automated driving function may comprise or may be a driving function that outputs a control signal acting on a vehicle HMI of the vehicle.

Thereby, the systematic determination of safety-relevant map features and safety-relevant KPIs may be employed for automated driving functions that provide output to a vehicle driver.

The automated driving function may comprise or may be a driving function that outputs a control signal acting on a vehicle actuator of the vehicle.

Thereby, the systematic determination of safety-relevant map features and safety-relevant KPIs may be employed for automated driving functions that provide actuator control.

The method may further comprise performing, by an ADS of the vehicle, the automated driving function conditionally dependent on the electronic map data being in compliance with the criteria.

Vehicle safety is enhanced by executing the automated driving function conditionally dependent on the electronic map data being in compliance with the criteria.

The method may further comprise determining, by the at least one processing circuit, further safety-relevant KPIs causal for safe execution of one or several further automated driving functions by the vehicle.

Thereby, the determination of safety-relevant map features and safety-relevant KPIs may be performed successively or in parallel for various different automated driving functions. The processing used to determine the safety-relevant map features and safety-relevant KPIs may respectively be performed as described in detail above and as further described in detail in association with embodiments below.

The verification that the electronic map data to be used in performing the automated driving function has all required map features and safety-relevant KPIs may be performed individually for each automated driving function. Individual automated driving functions may be selectively activated depending on whether the electronic map data used by the specific automated driving function has the safety-relevant map features and safety-relevant KPIs determined for the specific automated driving function.

Thereby, vehicle safety is enhanced further.

The method may further comprise using the one or several safety-relevant map features and the one or several safety-relevant KPIs for controlling one, several, or all of: a modification of the electronic map to conform with the one or several safety-relevant map features and the one or several safety-relevant KPIs; a distribution of updates of the electronic map; activation of the automated driving function; execution of the automated driving function; activation and deactivation of an advanced driving system; limiting operation to driver assistance mode (driver assistance level 0 or 1) until the map data meets the required criteria. These actions may be performed by or with the use of an electronic map server, a fleet management system, or a vehicle ADS.

The actions are appropriate to ensure that the electronic map data, possibly of the modification, have the map features and KPIs of the map features that are relevant for ensuring that the electronic map data does not prejudice safe execution of the automated driving function. Thereby, vehicle safety is enhanced further.

Determining the safety-relevant map features and the safety-relevant KPIs may be done by verifying conformity with the one or several safety goals (SG).

Thereby, the safety-relevant map features and the safety-relevant KPIs may be determined systematically based on specified safety goals.

A method of controlling vehicle operation according to an embodiment comprises performing the method of any one of the preceding claims to determine the one or several safety-relevant map features and the one or several safety-relevant KPIs; selectively activating the automated driving function in response to determining that the electronic map data has the one or several safety-relevant map features and the one or several safety-relevant KPIs; and controlling, by the automated driving function, at least one vehicle component.

The method may comprise controlling at least one HMI of or coupled to a processing system to enable the one or several safety goals to be specified via the HMI, wherein the processing system determines the safety-relevant map features and the safety-relevant KPIs based on the specified one or several SGs. The HMI via which the safety goal(s) can be specified is distinct from an onboard HMI of a vehicle.

Thereby, the one or several safety goals can be readily input for performing the method.

According to another aspect of the invention, there is provided a processing system. The processing system comprises at least one processing circuit operative to determine, for the electronic map, one or several safety-relevant map features and one or several safety-relevant key performance indicators (KPIs) of at least one of the one or several safety-relevant map features, wherein the one or several safety-relevant KPIs are causal for safe execution of an automated driving function by a vehicle. The at least one processing circuit is operative to perform the following operations to determine the one or several safety-relevant map features and the one or several safety-relevant KPIs: identifying one or several map features that affect execution of the automated driving function; determining the one or several safety-relevant map features, comprising determining which of the identified one or several map features are causal for at least one malfunction of the automated driving function; establishing, for each of the one or several safety-relevant map features, one or several KPIs of the safety-relevant map feature causal for at least one malfunction of the automated driving function; and determining the one or several safety-relevant KPIs for the one or several safety-relevant map features based at least on the established KPIs causal for the at least one malfunction. The processing system may be operative to perform or enable a verification that electronic map data to be used in the execution of the automated driving function complies with criteria that are based at least on the one or several safety-relevant map features and the one or several safety-relevant KPIs of the one or several safety-relevant map features.

Various effects and advantages are associated with the processing system. By determining both which map feature(s) electronic map data must have for safe execution of an automated function and which KPIs are required, appropriate measures can be taken by the processing system to ensure that electronic map data to be used for performing an automated driving function has both the map features and the KPIs that are required for the automated driving function to be performed in a safe manner.

The processing system may be operative to perform the method according to an embodiment.

The effects attained by the optional features discussed in association with the optional features of the method correspond to the effects already mentioned in association with the method.

A vehicle according to an embodiment comprises a vehicle system operative to execute an automated driving function. The vehicle system comprises at least part of the processing system and/or the vehicle processing system is operative to receive data relating to the one or several safety-relevant map features and the one or several safety-relevant key performance indicators (KPIs) determined using a method according to an embodiment, and to perform at least one automated function based on the received data relating to the one or several safety-relevant map features and the one or several safety-relevant key performance indicators.

Various effects and advantages are associated with vehicle. By using information on which map feature(s) electronic map data must have for safe execution of an automated function and which KPIs are required, appropriate measures can be taken by the vehicle to ensure that electronic map data to be used for performing an automated driving function has both the map features and the KPIs that are required for the automated driving function to be performed in a safe manner.

The vehicle system may be an automated driving system (ADS).

Thereby, the data related to the map features and their KPIs that are required for safe execution of the automated function may be used by the ADS.

The ADS may be operative to perform one, several or all of the following: selecting electronic map data from several electronic maps available to the ADS in accordance with the received data relating to the safety-relevant map features and the safety-relevant KPIs; requesting an over-the-air (OTA) update of electronic map data available to the ADS; selectively activating the automated driving function conditionally dependent on whether the electronic map data has the one or several safety-relevant map features and the one or several safety-relevant KPIs; selectively activating a fallback function for an automated driving function conditionally dependent on whether the electronic map data has the one or several safety-relevant map features and the one or several safety-relevant KPIs.

Vehicle safety is enhanced thereby.

The ADS may be operative to control at least one vehicle actuator of the vehicle when performing the automated driving function.

Thereby, the techniques disclosed herein are harnessed for enhancing vehicle safety upon execution of automated driving functions that control one or several vehicle actuators.

According to a further aspect of the invention, there is provided a system comprising the processing system according to an embodiment and a vehicle comprising an automated driving system (ADS), the ADS being operative to perform an automated driving function conditionally dependent on whether the electronic map data has the one or several safety-relevant map features and the one or several safety-relevant KPIs.

Vehicle safety is enhanced thereby.

According to a further aspect of the invention, there is provided a use of the method, the processing system, and/or the vehicle according to an embodiment for preventing map-induced malfunctions in the performance of an automated driving function.

Thereby, the information on the map features and KPIs that are required to ensure that there are no map-induced malfunctions in the performance of the automated driving function.

The automated driving function may comprise or may be an automated driving function at any one of driving automation levels 1, 2, 3, 4, or 5. The automated driving function may comprise or may be an automated driving function that provides driver assistance or an automated driving function that provides enhanced driver assistance or an automated driving function that provides autonomous driving functionality.

Thereby, the systematic determination of safety-relevant map features and safety-relevant KPIs may be employed for both driver assistance and autonomous driving, which involve different degrees of automation. This further enhances vehicle safety.

According to another aspect of the invention, there is disclosed machine-readable instruction code comprising instructions which, when executed by at least one processing circuit, cause the at least one processing circuit to perform the method of any one aspect or embodiment.

According to another aspect of the invention, there is disclosed a data carrier comprising machine-readable instruction code comprising instructions which, when executed by at least one processing circuit, cause the at least one processing circuit to perform the method of any one aspect or embodiment.

The data carrier may comprise a non-transitory storage medium having stored thereon the machine-readable instruction code.

While the techniques disclosed herein may be used for driver assistance and autonomous driving functions, they are not limited thereto.

### BRIEF DESCRIPTION OF THE DRAWINGS

Embodiments of the invention will be described with reference to the drawings in which similar or corresponding reference signs designate elements having similar or corresponding configuration and/or function.

FIG. 1 is a diagram of a system comprising a processing system and a vehicle.

FIG. 2 is a block diagram of the processing system.

FIG. 3 is a flow chart of a method.

FIG. 4 is a flow chart of a method.

FIG. 5 is a flow chart of a method.

FIG. 6 is a schematic representation of causality analysis that may be performed by the methods and processing systems.

FIG. 7 is a schematic representation of causality analysis that may be performed by the methods and processing systems.

FIG. 8 is a flow chart of a method.

FIG. 9 is a high level diagram of a lane keeping control.

FIG. 10 illustrates map features relevant to lane keeping control.

FIG. 11 is a diagram illustrating determination and use of data for enhancing vehicle safety.

FIG. 12 is a diagram illustrating determination and use of data for enhancing vehicle safety.

FIG. 13 is a block diagram of a vehicle.

FIG. 14 is a diagram illustrating determination and use of data for enhancing vehicle safety.

FIG. 15 is a diagram of a system comprising a processing system and a vehicle.

### DETAILED DESCRIPTION OF EMBODIMENTS

Embodiments of the invention will be described in detail. While embodiments will be described in association with autonomous driving or driver assistance functions, the embodiments are not limited thereto. The embodiments may be used in association with various automated driving functions at driving automation levels 1, 2, 3, 4, or 5.

The features of embodiments may be combined with each other unless specifically stated otherwise.

The techniques disclosed herein in detail may be used to enhance safety of automated driving functions executed by a vehicle. More specifically, the techniques disclosed herein are operative to systematically determine which map features and key performance indicators (KPIs) of the map features must be present in electronic map data to mitigate the risk of the map data causing malfunction of an automated driving function.

As used herein, an electronic map and electronic map data refers to data defining a navigable network comprising a plurality of navigable segments along which a vehicle (such as a motor vehicle and/or unmotorized vehicle such as a bike) or other movable element can move. The electronic map and electronic map data may comprise map features such as lane markings, traffic signs, lane boundaries. Such map features may be included in the electronic map as attributes or may be included in separate, dedicated map layers.

As used herein, a map feature and KPIs of the map feature are determined as being “safety-relevant” for performance of an automated driving function by an automated driving system (ADS) of a vehicle if electronic map data that does not have the safety-relevant map feature or that does not have the safety-relevant KPI can cause a malfunction of the automated driving function. Thus, the determination of one or several safety-relevant map feature(s) and its or their safety-relevant KPI(s) is with reference to an automated driving functions. The safety-relevant map feature(s) and safety-relevant KPI(s) can vary from one automated driving function to another. While the techniques disclosed herein are primarily discussed in association with an automated driving function, they may be applied to determine and use the safety-relevant map features and KPIs for several automated driving functions executable by an ADS.

Safety of execution of an automated driving function may be determined based on one or several safety goals (SGs). The SGs may be predefined or may be configurable, e.g., by controlling a human machine interface (HMI) to allow the SGs to be specified, with the HMI being coupled to or comprised by a computing system that performs the determination of the map features and KPIs required for safe execution of an AD function.

As used herein, the term KPI of a map feature may refer to a KPI selected from a pre-defined KPI set. The KPI set may comprise or consist of KPIs in accordance with, or compatible with, ISO 19157:2013.

The pre-defined KPI set may comprise or may consist of:
Accuracy: Accuracy can be defined as the closeness of agreement between a test result or measurement result and the true value. This can be broken down into several categories:
   Positional accuracy: It relates to measurement accuracy, and it represents a closeness of agreement between a measured position of features and a position accepted as true within a spatial reference system. Depending on the scope and a type of the reference system, this standard specifies the following three data quality elements for expressing positional accuracy:
   Absolute or external accuracy: closeness of reported coordinate values to values accepted as true in a standard coordinate reference system;
   Relative or internal accuracy: closeness of the relative positions of features in a related dataset to their respective relative positions accepted as true in a local coordinate reference system;
   Thematic accuracy: Thematic quality may be defined as the accuracy of quantitative attributes and the correctness of non-quantitative attributes and of the classifications of features and their relationships. Three quality elements are specified within thematic accuracy which are as follows:
      Classification correctness: comparison of the classes assigned to features or their attributes to a universe of discourse (e.g., ground truth or reference data)
      Freshness of the map: How close is the map in comparison to reality can be termed as freshness of the map.
      Coverage: Coverage represents the presence or absence of topics, their attributes, and relationships according to the regional scope of the product
      Completeness of the map: Completeness refers to the presence and/or absence of features, their attributes, and relationship.

The KPIs of map features used for performing an automated driving (AD) function may be different from the KPIs of navigable segments or points of interest (POIs), for example. For illustration, an AD function may use lane boundaries in combination with sensor data to determine, by fusion of the sensor data and the map feature (lane boundaries), a world model (i.e., a model of a surrounding of the vehicle). The map feature used in performing the AD function (lane boundaries) may have a coverage, freshness, or completeness that is different from that of navigable segments of a navigable network.

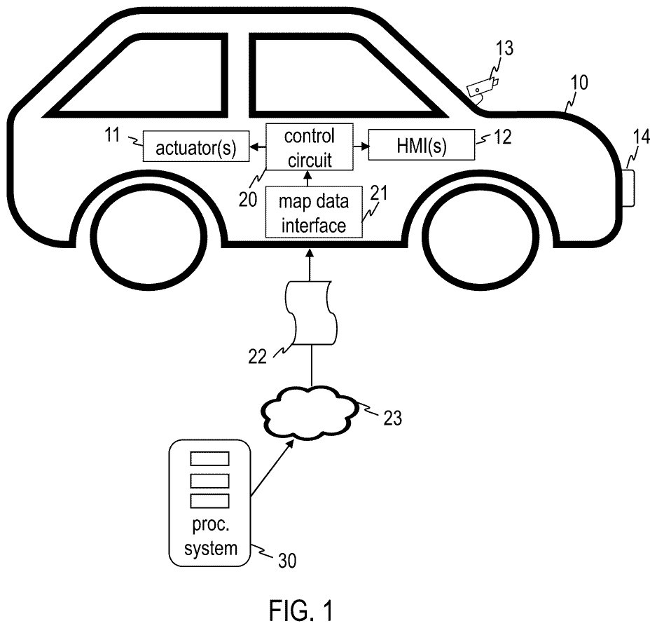

FIG. 1 is a schematic representation of a system. The system comprises a processing system 30 and a vehicle 10 according to an embodiment. The vehicle 10 comprises one or several actuators 11 and/or one or several HMI(s) 12 controlled by at least one control circuit 20. The one or several actuators 11 may comprise at least one vehicle speed actuator (which may control an engine or brake) and/or a steering direction actuator (which may control wheel steering orientation). The one or several HMI(s) 12 may comprise an optical output device and/or device(s) providing audible or tactile feedback.

The vehicle 10 may comprise at least one vehicle sensor. The at least one vehicle sensor may comprise a camera 13, a ranging sensor 14 (which may be a LIDAR-based sensor, for example), a global navigation satellite system (GNSS) receiver, and/or other sensors.

The at least one control circuit 20 may comprise an ADS electronic control unit (ECU). The ADS ECU may be operative to perform at least one (and typically several) AD functions. The AD functions may comprise AD functions at various driving automation levels, such as level 1 or level 2 or level 3 or level 4 or level 5. The at least one control circuit 20 may be operative to perform a fusion of electronic map data and sensor data captured by the at least one sensor to determine a world model of an area surrounding the vehicle and to perform the AD function(s) based thereon.

To mitigate the risk of malfunction(s) of an AD function being caused by the electronic map data, there is provided a processing system 30. The processing system 30 determines which one or several map features and their KPIs are safety-relevant in the sense that absence of the respective map feature(s) or KPIs can cause at least one malfunction of the respective AD function. The processing system 30, a map server system, and/or the vehicle 10 may use the determined safety-relevant map feature(s) and KPI(s) to mitigate the risk of map data-induced malfunctions of the AD function. This can be done in various ways, such as by (a) selectively activating the AD function conditionally dependent on a verification that the electronic map data has the map feature(s) and KPI(s) determined to be safety-relevant for the respective AD function; (b) providing updated electronic map data to the vehicle 10; (c) providing an OTA update for performance of the AD function to the vehicle 10; without being limited thereto. The vehicle 10 may comprise an OTA interface 21 to receive map data 22 and/or data specifying the map feature(s) and KPI(s) determined to be safety-relevant for the respective AD function. The OTA interface 21 may be communicatively interfaced with the processing system 30 over at least one communication link. The at least one communication link may be a communication link of a communication network 23, which may comprise a wireless communication system, in particular a cellular communication system, and/or a wide area network (WAN) and/or a communication system for a cloud-based processing system.

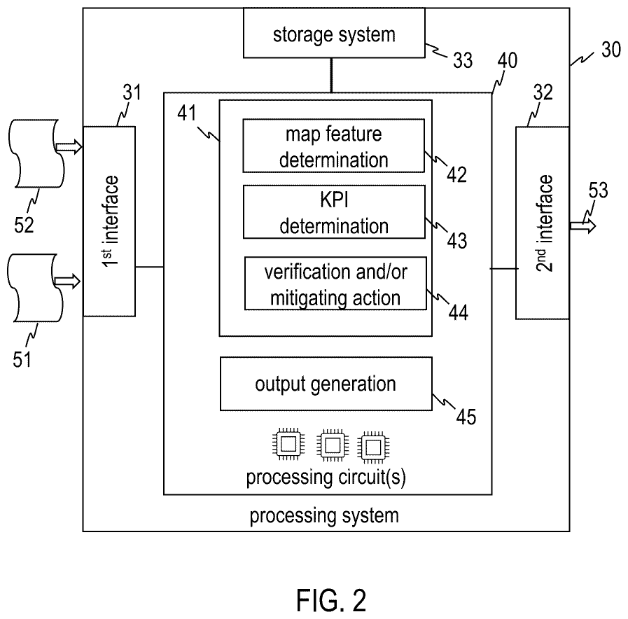

The operation and configuration of a processing system 30 comprising one or several processing circuit(s) to perform the various processing functions is described in more detail with reference to FIGS. 2 to 10.

FIG. 2 is a block diagram of the processing system 30. The processing system 30 comprises at least one first interface 31 operative to receive an electronic map 51 and system model data 52 relating to performance of an AD function or several AD functions by an ADS of a vehicle 10. While the following explanations will focus on the processing for an AD function, the processing operations and actions disclosed below can, and typically will, be performed by the processing system 30 for each of a set of AD functions. The AD functions for which the processing is performed may comprise AD functions of different driving automation levels, such as at least two different automation levels selected from automation levels 1, 2, 3, 4, or 5. The determination of safety-relevant map features and KPIs may be performed in parallel or sequentially for the different AD functions. The safety-relevant map features and KPIs may be determined per AD function and may be used to ensure that the respective AD function, if performed, is not prone to map data-induced malfunctions.

The system model data 52 may define whether and, if so, how electronic map data is used or may be used for performing the AD function. The system model data 52 may be comprise a generic model defining which data elements are fused to perform a certain function (such as by defining that lane boundaries of an electronic map are used in combination with camera images). The system model data 52 may be independent of the specific logic operations that define how the data elements are logically combined, allowing the techniques disclosed herein to be applicable to a wide variety of implementations that may be proprietary for various vehicles models or ADS suppliers. The system model data 52 may also comprise information on the specific logical implementation defining how map features and sensor data are available if such information is available.

The processing system 30 may be operative to process the system model data 52 and, optionally, the electronic map data 51 to generate and provide output 53. The output 53 may comprise an output that ensures that electronic map data used by the ADS of the vehicle 10 does not cause a malfunction of the AD function. Alternatively or additionally, the output 53 may comprise an output used by a device or system different from the processing system (such as the vehicle 10, a map server, an OTA update server, a fleet management server for vehicles) to ensure that electronic map data used by the ADS of the vehicle 10 does not cause a malfunction of the AD function. The output 53 may comprise data defining the safety-relevant map features and the safety-relevant KPIs for each of one or more AD functions. Such data defining the safety-relevant map features and the safety-relevant KPIs may be used by the vehicle 10, the map server, the OTA update server, or the fleet management server to ensure that electronic map data used by the vehicle 10 in performing the AD function has the safety-relevant map features and KPIs determined by the processing system 30 for the respective AD function. Alternatively or additionally, the output 53 may comprise electronic map data that has been verified by the processing system 30 to have the safety-relevant map features and KPIs determined by the processing system 30 for the respective AD function. The processing system 30 may comprise functions of a map server and/or an OTA update server and/or a fleet management system and may provide electronic map data or updates, verified for their conformity with the determined safety-relevant map features and KPIs, for use by the vehicle 10.

The processing system 30 may store the map data 51 and/or the system model data 52 in a storage system 33 of the processing system 30 or in a storage system accessible to the processing system 30 for use in the processing operations. The processing system 30 comprises the storage system 33. The storage system 33 is operative to store at least the system model(s) for at least one ADS. Thus, the storage system 33 may have stored therein data that indicates which types of electronic map data (i.e., which map features) are used, alone or generally in combination with sensor data, to determine a world model used in execution of the AD function.

The processing system 30 comprises at least one processing circuit 40. The at least one processing circuit 40 may comprise any one or any combination of integrated circuits, integrated semiconductor circuits, processors, controllers, application specific integrated circuits (ASICs), field programmable gate arrays (FPGAs), circuit(s) including quantum bits (qubits) and/or quantum gates, without being limited thereto.

The at least one processing circuit 40 may be implemented in one device, such as a device selected from a group consisting of a server remote from the vehicle (such as a processing server, a map server or OTA update server), a fleet management system, and the vehicle 10. The at least one processing circuit 40 may comprise circuits of a distributed system implemented in at least two devices, such as two or more devices selected from a group consisting of a server remote from the vehicle (such as a map server or OTA update server), a fleet management system, and the vehicle 10.

The at least one processing circuit 40 is operative to perform a processing 41 to determine one or several map features and KPIs of the one or several map features, which, when missing in electronic map data, have the potential of causing at least one map data-induced malfunction of the AD function. These map feature(s) and KPI(s) are also referred to as “safety-relevant” map features and KPIs, respectively.

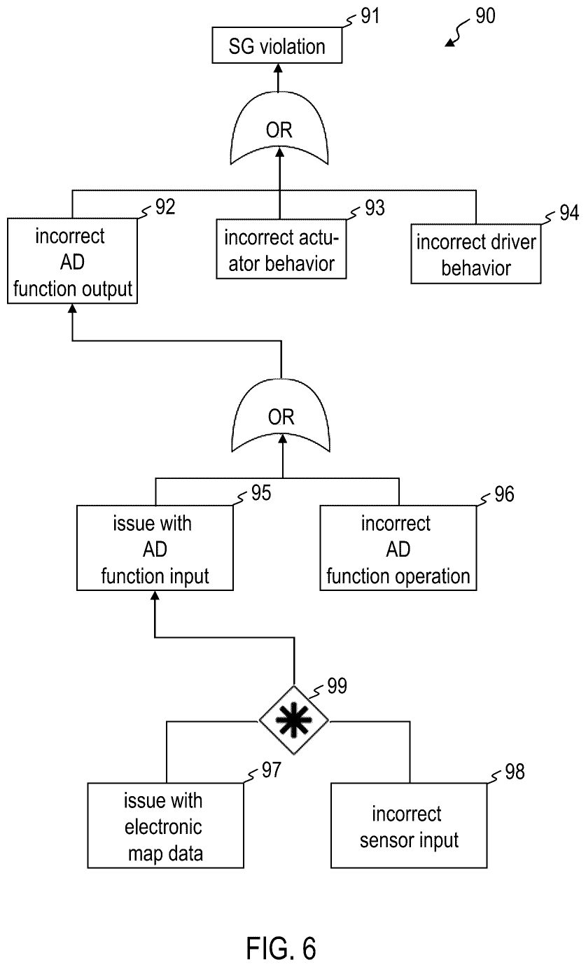

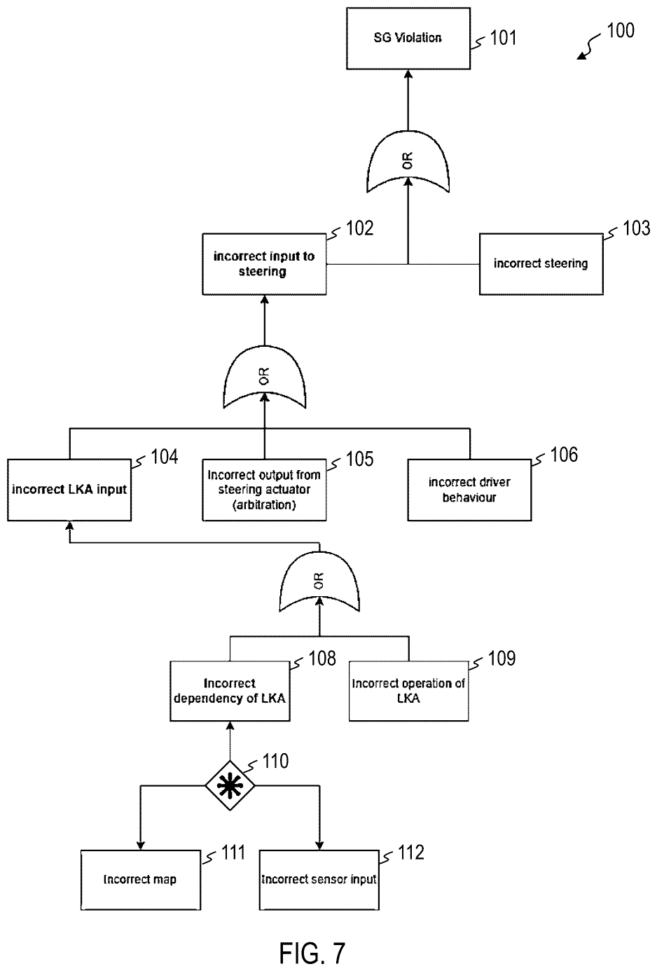

The processing 41 may receive at least the system model data 52 and, if present, the electronic map 51 as input. The processing 41 may comprise a determination 42 of one or several safety-relevant map features. The map feature determination 42 may comprise identifying one or several map features (such as map features related to road boundaries, lane boundaries, traffic signs) that will or potentially will be used by the AD function. The determination 42 may comprise identifying which of these map feature, if missing in the electronic map data, has the potential to cause a map data induced malfunction. As used herein, a map data induced malfunction is a malfunction that can be present even when the sensor data used for performing the AD function are correct. Determining which map feature(s) can be causal for at least one malfunction may comprise performing a causality analysis. The causality analysis may comprise a Bayesian network (BN) or fault tree analysis, without being limited thereto. Examples of such causality analyses are provided and will be explained in more detail with reference to FIGS. 6 and 7.

The processing 41 may comprise a determination 43 of one or several safety-relevant KPIs for the map features determined to be safety-relevant. As noted above, the KPIs in map data may be different for map features such as related to road boundaries, lane boundaries, traffic signs and navigable segments of the navigable network represented by the electronic map. The KPI determination 43 may comprise identifying one or several KPIs (such as accuracy, freshness, correctness, coverage) that, if missing, can cause a map induced malfunction of the AD function. Determining which KPIs can be causal for at least one malfunction may comprise performing another causality analysis. The other causality analysis may comprise a Bayesian network (BN) or fault tree analysis, without being limited thereto.

The processing 41 may comprise a verification 44 of electronic map data and/or the implementation of a mitigating action, based on a check of the map data 51 against the determined one or several safety-relevant map feature(s) and KPI(s). The verification 44 may comprise verifying whether the electronic map data used in execution of the AD function has the one or several safety-relevant map feature(s) and KPI(s). In response to determining that the electronic map data does not have the one or several safety-relevant map feature(s), a mitigating action is initiated or performance of a mitigating action is enabled. Likewise, in response to determining that the electronic map data does not have the one or several safety-relevant KPIs of the one or several safety-relevant map features, a mitigating action is initiated or performance of a mitigating action is enabled.

The mitigating action may comprise any one or any combination of: modifying the electronic map data (e.g., by performing map merging or otherwise combining information from electronic maps having different map feature(s) and/or KPI(s) of the map feature(s)) to ensure that the electronic map data used by the ADS complies with the safety-relevant map feature(s) and KPI(s); causing provision of an OTA map update to the vehicle to ensure that the electronic map data used by the ADS complies with the safety-relevant map feature(s) and KPI(s); enabling a selective activation of the AD function by the ADS responsive to a verification that the electronic map data has the safety-relevant map feature(s) and KPI(s) for that AD function; activating a fallback AD function different from the AD function by the ADS responsive to a verification that the electronic map data does not have the safety-relevant map feature(s) and/or does not have the safety-relevant KPI(s) determined for that AD function; deactivating the ADS until the map data received meets the required criteria; operating in driver assistance mode (driver assistance level 0 or 1) until the map data received meets the required criteria.

The output 53 that comprises electronic map data verified to have the required safety-relevant map feature(s) and KPI(s) may be provided via the at least one first interface 31 or at least one second interface 32 (which may be interfaced with a wide area network 23 or a cellular network) for use by the vehicle 10, a map servers, an OTA update server, or a fleet management system.

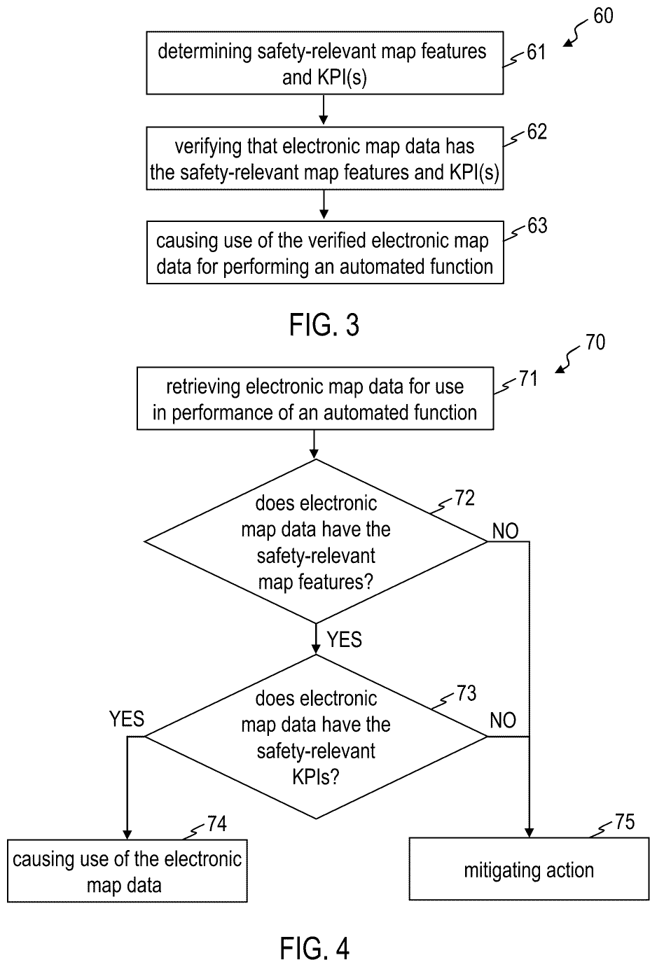

FIG. 3 is a flow chart of a method 60. The method 60 may be performed automatically by the at least one processing circuit 40, alone or in combination with another device (such as the vehicle 10, a map server, an OTA update server, etc.).

At process block 61, one or several safety-relevant map feature(s) and KPI(s) are determined. Determining the safety-relevant map feature(s) may comprise performing, using the system model for performance of the AD function, a causality analysis to identify the safety-relevant map features as one or several map features which, if missing, cause the AD function to have at least one malfunction. Determining the safety-relevant KPI(s) may comprise performing, using the system model for performance of the AD function, a causality analysis to identify the safety-relevant KPI(s) as one or several KPI(s) which, if not present in the manner as desired, cause the AD function to have at least one malfunction.

The malfunction(s) may be represented by failure of meeting one or several safety goals (SGs). The one or several SGs may be fixed or configurable, e.g., via an HMI of the processing system 30. The processing system 30 may be operative to control the HMI to enable the SGs to be specified. It is noted that the HMI of the processing system 30 should not be confused with an onboard HMI that may be present in a vehicle.

At process block 62, a verification is performed. The verification may comprise checking map data to verify that it has both the one or several safety-relevant map feature(s) and the one or several safety-relevant KPI(s). The verification at process block 62 may comprise checking which map features (such as map features relating to road boundaries, lane boundaries, and/or traffic signs) are present in the map data and comparing these map features with the safety-relevant map feature(s). The verification at process block 62 may comprise checking which KPIs the safety-relevant map feature(s) have in the map data (such as by retrieving the accuracy, freshness, coverage, and/or completeness) and comparing these KPI(s) of the map features with the safety-relevant KPI(s).

At process block 63, use of the verified electronic map data for performing the AD function is enabled if the electronic map data has been verified to have the one or several safety-relevant map feature(s) and the one or several safety-relevant KPI(s). Otherwise, a mitigating action is initiated to mitigate the risk of a map data induced malfunction in performance of the AD function.

FIG. 4 is a flow chart of a method 70. The method 70 may be performed automatically by the at least one processing circuit 40, alone or in combination with another device (such as the vehicle 10, a map server, an OTA update server, etc.), by the control circuit 20 of the vehicle 10, or by another device or system. The method 70 may be performed to implement process blocks 62 and 63 of the method 60 of FIG. 3.

At process block 71, electronic map data is retrieved for use in performance of an AD function. Retrieval of the electronic map data may comprise an OTA retrieval of the electronic map data by the vehicle 10, based on a location, driving direction, and optionally velocity of the vehicle 10. Retrieval of the electronic map data may comprise a retrieval of the electronic map data by the at least one processing circuit 40 or a map server, based on a location, driving direction, and optionally velocity of the vehicle 10.

At process block 72, it is determined whether the retrieved electronic map data has the safety-relevant map feature(s). The verification at process block 72 may comprise checking which map features (such as map features relating to road boundaries, lane boundaries, and/or traffic signs) are present in the map data and comparing these map features with the safety-relevant map feature(s). If at least one safety-relevant map feature is not present, the method proceeds to process block 75. Otherwise, the method continues at process block 73.

At process block 73, it is determined whether the retrieved electronic map data has the safety-relevant KPI(s). The verification at process block 73 may comprise checking which KPIs the safety-relevant map feature(s) have in the map data (such as by retrieving the accuracy, freshness, coverage, and/or completeness) and comparing these KPI(s) of the map features with the safety-relevant KPI(s). If at least one safety-relevant KPI for at least one of the safety-relevant map features is not present, the method proceeds to process block 75. Otherwise, the method continues at process block 74.

At process block 74, if both the safety-relevant map features and the safety-relevant KPI(s) are present, use of the electronic map data for performing the AD function is authorized. This may be done in various ways, such as by selectively activating the AD function in response to and conditionally dependent on successful verification that both the safety-relevant map features and the safety-relevant KPI(s) are present. Alternatively or additionally, the AD function (or ADS) may be deactivated when the vehicle is about to exit an operational design domain (ODD).

At process block 75, if the safety-relevant map features and/or the safety-relevant KPI(s) are not present, a mitigating action may be performed. The mitigating action may comprise any one or any combination of:
modifying the electronic map data by the processing system 30 or a map server different therefrom (e.g., by performing map merging or otherwise combining information from electronic maps having different map feature(s) and/or KPI(s) of the map feature(s)) to ensure that the electronic map data used by the ADS complies with the safety-relevant map feature(s) and KPI(s);
causing, by the processing system 30 or by an OTA server different therefrom, provision of an OTA map update to the vehicle to ensure that the electronic map data used by the ADS complies with the safety-relevant map feature(s) and KPI(s);
performing, by the ADS, a selective activation of the AD function responsive to a verification that the electronic map data has the safety-relevant map feature(s) and KPI(s) for that AD function;
activating, by the ADS, a fallback AD function different from the AD function by the ADS responsive to a verification that the electronic map data does not have the safety-relevant map feature(s) and/or does not have the safety-relevant KPI(s) determined for that AD function;
reverting, by the ADS, by the processing system 30 or by an OTA server different from the processing system 30, to an older version of the electronic map that has the safety-relevant map features and KPIs.

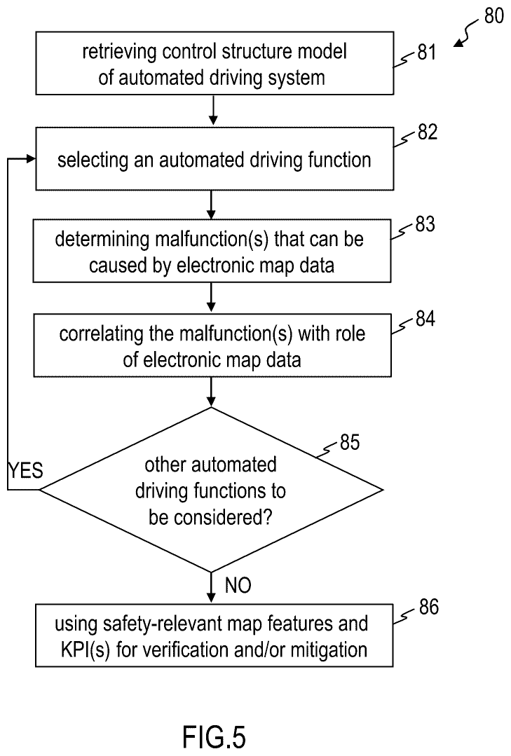

FIG. 5 is a flow chart of a method 80. The method 80 may be performed automatically by the at least one processing circuit 40, alone or in combination with another device (such as the vehicle 10, a map server, an OTA update server, etc.). The method 80 may be performed to implement process block 61 of the method 60 of FIG. 3.

At process block 81, a control structure model of the ADS is retrieved. The control structure model may define which AD functions use electronic map data (and more specifically use various map feature(s), such as map feature(s) relating to lane boundaries and/or traffic signs) to perform the respective AD function, alone or—typically—in combination with sensor data. The control structure model may include information on how (i.e., by which logic gates) fusion of electronic map data and sensor data is performed by the ADS to generate a world model of vehicle surroundings. However, and importantly, the techniques disclosed herein remain operative even if the detailed implementation of the fusion of electronic map data and sensor data is unknown, as long as the control structure model allows the processing circuit(s) 40 to determine which map feature(s) are used to generate a world model (or otherwise) to perform an AD function.

At process block 82, an AD function is selected. The AD function may be selected from a set of AD functions of the control structure model.

At process block 83, malfunctions of the AD function are determined which can be caused by the electronic map data. Determining the malfunctions that can be caused by the electronic map data may comprise a causality analysis. The causality analysis may be implemented using a BN or fault tree, without being limited thereto. The causality analysis may be performed under an assumption that all inputs and operations other than the electronic map data are fault-free.

At process block 84, the determined malfunction(s) may be correlated with the electronic map data. The correlation may be performed as explained with reference to FIG. 4, for example. In particular, the malfunction(s) may be traced back to map feature(s) of the map data that, if missing, may cause at least one malfunction. The malfunction(s) may additionally be traced back to KPI(s) of these map feature(s) that, if not having the required characteristics (such as accuracy, freshness, coverage, completeness), may cause at least one malfunction.

At process block 85, it is determined whether there are any other AD functions of the control structure model which are yet to be considered. If there are other AD functions yet to be considered, the method returns to process block 82. Otherwise, the method proceeds to process block 86.

At process block 86, the determined safety-relevant map feature(s) and KPI(s) are used to verify whether the electronic map data has the determined safety-relevant map feature(s) and KPI(s) and/or to take a mitigating action, if required. Process block 86 may be implemented using the method 70 of FIG. 4.

The processing system, vehicle, and methods discussed in detail above and further described below provide a framework designed for the identification of safety-relevant map features and their respective KPIs for AD. The role of maps in AD has been demonstrated by different approaches employed by original equipment manufacturers (OEMs). The safety of AD functions depends on a wide set of factors with the map data being one important factor.

The role of a map in the safe operation of automated driving is an important consideration. Approaches are available to trace the malfunction of the AD applications to the sub-system level where map feature(s) are being used. The techniques disclosed herein provide an enhanced approach to identify the role electronic maps play in ensuring safe and reliable operation of an ADS. The system, vehicle, and methods disclosed herein can be applied to any defined level of vehicle automation. The system, vehicle, and methods disclosed herein can be applied to any given AD application using a map feature to identify safety relevant map feature KPIs. The system, vehicle, and methods disclosed herein can also be deployed within the bounds of the vehicle using a runtime application which can enable safe operation of AD functions.

The techniques disclosed herein may be leveraged by OEMs, Tier 1 suppliers that provide components of ADAS or AD system components, and providers of map data (such as Tier 2 suppliers). Practical implementations include, without limitation:
OEMs: OEMs to determine which map features, used in the safe operation of ADAS/AD systems, are safety relevant. Furthermore, the KPIs used for tracking quality for these safety critical map features can also be determined using the techniques disclosed herein. For illustration, to develop a L3 AD system which performs lane keeping, the techniques disclosed herein will yield lane features as a safety critical map feature. The safety relevant KPIs for this function are determined to be, e.g., accuracy, freshness, completeness, etc.
Tier 1: The techniques disclosed herein could be applied by Tier 1 manufacturers which are responsible for developing and integrating the components of an ADS for the OEMs.
Map providers: The techniques disclosed herein can be used by any map provider to determine a list of safety critical map features and its quality parameters. The techniques disclosed herein enable a map provider to develop a map suitable for broad set of use cases thereby encompassing a larger portion of the automotive market. Since the techniques disclosed herein do not require data or involvement from OEMs, the techniques may be used in planning future developments of products which cater to the needs of the growing AD industry. Moreover, the techniques disclosed herein can also be used as a baseline for verifying requirements received from OEMs, thereby ensuring the map providers are developing products at the same pace as the industry.

The processing system, vehicle, and methods are particularly useful for determining characteristics of electronic map data for use in AD functions. For illustration, various electronic maps that are distinguished from each other by map feature(s) and/or their KPI(s) may be evaluated, using the determined safety-relevant map feature(s) and KPI(s) as reference that must be fulfilled. A determination may be made as to map selection and/or map merging operations that are to be performed to mitigate the risk of map data induced malfunctions. A further benefit of the techniques disclosed herein is that they do not require the control system model to include details on the fusion logic (e.g., details on the logic gates) used to fuse map data and electronic map data to generate a world model for performing the AD function.

In the techniques disclosed herein, KPIs are identified via a top-down safety analysis performed on the AD system. The top-down analysis may be based of multiple safety analysis techniques.

To perform the determination of safety-relevant map features and their KPI(s), a definition of the AD system with its required functionalities may be used (as at process block 81 in FIG. 5). The definition of the automation of the AD system may be in accordance with SAE J3016 (e.g., as in force on the filing or priority date of this application). The boundaries of the AD system are also taken into consideration during the system definition phase. In addition to the system definition, the role of map in performing its required functions is used. A definition of the latter may include a list of map features to be used by the AD system in performing its required maneuvers. An implementation of such a system definition is a Systems Theoretic Process Analysis (STPA) control structure of the AD system under analysis. The control structures are modelled to the point where the subsystem using maps are identified.

Tracing the malfunctions (as in process block 83 in FIG. 5) may comprise tracing each malfunction of each AD function to a subsystem and component level. The result of this process concerns the map data being used in performing the analyzed AD function. Malfunctions caused by the components of the AD system which do not have any association with the map will not be further considered in this process. An embodiment of this process can comprise a causality analysis, such as a fault tree analysis, event tree analysis or using a Bayesian network, as illustrated in FIG. 6 and FIG. 7.

Correlating the malfunctions with map quality (as in process block 84 in FIG. 5) may comprise determining the impact each malfunction has on the AD function. Using these malfunctions, a list of safety-relevant map KPIs are also obtained. This process is repeated for each map feature required for performing the defined AD function. The KPIs are used to evaluate the quality of the map. The KPIs may be defined based on ISO 19157:2013. The KPIs accuracy, classification, freshness, coverage, completeness, which were already mentioned, are a subset of the available KPIs for evaluating a map's quality. Definitions of these KPIs were already provided herein above.

These identified map KPIs that are present in the electronic map data are to be evaluated against the list of KPIs that are identified as being safety-relevant. This evaluation may be performed in process blocks 83, 84 in FIG. 5 and process blocks 61, 62 in FIG. 3. This results in the identification of a subset of safety relevant KPIs which can be used for defining safety requirements for maps.

The malfunctions, which may optionally be ranked, can be correlated with map KPIs. This verification may be performed at process block 63 in FIG. 3 and process block 86 in FIG. 5. The correlation is generally performed with respect to all the safety-relevant KPIs. Weights can be assigned to each KPI depending on the AD functionality being considered.

One implementation of this step may comprise assigning a higher weight to accuracy and a lower weight to completeness when the control system definition of the AD system requires a map with high accuracy. The result of this correlation is a list of ranked safety relevant map KPIs, which may be correlated with map KPIs as in process block 63 in FIG. 3 and process block 86 in FIG. 5.

The system definition process of the ADS system requires the elicitation of requirements on the AD system and its use cases. If the AD system undergoes a design change or changes in requirements, the processing is repeated to ensure the relevancy of the results.

While the identification of safety-relevant KPI(s) is applicable also when there is just one safety-relevant map feature, the process can also be employed when there are several safety-relevant map features for an AD function. In this case, the processing operations executed to determine the safety-relevant KPI(s) are performed for each of the safety-relevant map features. This may be done using parallel or sequential processing. Also in this case, the processing is reapplied if there is a change to the list of map features considered for the use case.

While techniques of identifying map-related KPIs for a specific use case by analyzing the inputs of the AD system have been previously applied, the defined framework aids in the identification of safety relevant map KPIs relevant to vehicle and AD system providers. Objective criteria are established for assessing and ensuring that map-related safety requirements are uniform, clear, and concise. By correlating use cases with the respective KPIs of the map, a relationship can be established between use cases (AD functions) and KPIs of map features that can cause a malfunction if the map data is not in accordance with these KPIs.

The techniques disclosed herein are operative to cascade safety of an AD application to the maps. This results in safety being introduced into the map domain due to the decomposition of safety requirements of the AD application.

As mentioned above, at least one causality analysis may be performed to determine which map feature(s) and/or which KPI(s) of the map feature(s) are causal for at least one malfunction. BN, fault tree, or event tree analysis may be used.

FIG. 6 illustrates an implementation of a causality analysis 90. In the causality analysis, it is determined whether a malfunction corresponding to a SG violation 91 can be caused by an electronic map. In the illustrated case, the SG violation is an incorrect steering or an incorrect acceleration operation or an incorrect braking operation, which may be caused by an incorrect AD function output 92, an incorrect actuator behavior 93, or an incorrect driver behavior 94. The purpose of the causality analysis 90 is to identify the map-related causes for possible malfunctions. Hence, the actuator behavior and driver behavior 94 are regarded to be correct. The incorrect AD function output 92 may be caused by an incorrect AD function operation 96 or an issue with the AD function input 95. As the specific implementation of the AD function logics is unknown and/or may vary from one OEM to another, the implementation of the AD function operation is considered to be correct. The issue with the AD function input 95 may be caused by an issue with the electronic map data 97 or sensor input 98. The electronic map data and sensor input 98 may be combined by the AD system in a potentially complex logics operation 99.

Using a fault analysis as in FIG. 6, malfunctions having a root cause in certain map feature(s) and KPI(s) thereof can be traced.

FIG. 7 illustrates a more specific implementation of a causality analysis 100 as applied to an incorrect steering behavior, i.e., a violation of a SG 101 relating to lane keeping. In the causality analysis, it is determined whether a malfunction corresponding to a SG violation 101 can be caused by an electronic map. In the illustrated case, the SG violation is an incorrect steering operation, which may be caused by an incorrect input to steering 102 or an incorrect implementation of the steering 103. To trace possible root causes of the SG violation 101 to map data, the implementation of the steering is regarded as being correct. The incorrect input to the steering 102 may be caused by an incorrect lane keeping assistance input 104, an incorrect steering actuator output 105, or an incorrect driver behavior 106. The purpose of the causality analysis 100 is to identify the map-related causes for possible malfunctions. Hence, the actuator behavior and driver behavior 105, 106 are regarded to be correct. The incorrect LKA input 104 may be caused by an incorrect dependency of the LKA function 108 or an incorrect operation 109 of the LKA function. As the specific implementation of the LKA function logics is unknown and/or may vary from one OEM to another, the implementation of the LKA function operation is considered to be correct. The issue with the AD function input 108 may be caused by an issue with the electronic map data 111 or sensor input 112. The electronic map data 11 and sensor input 112 may be combined by the AD system in a potentially complex logics operation 110.

Using a fault analysis as in FIG. 7, malfunctions of steering operations having a root cause in certain map feature(s) and KPI(s) thereof can be traced.

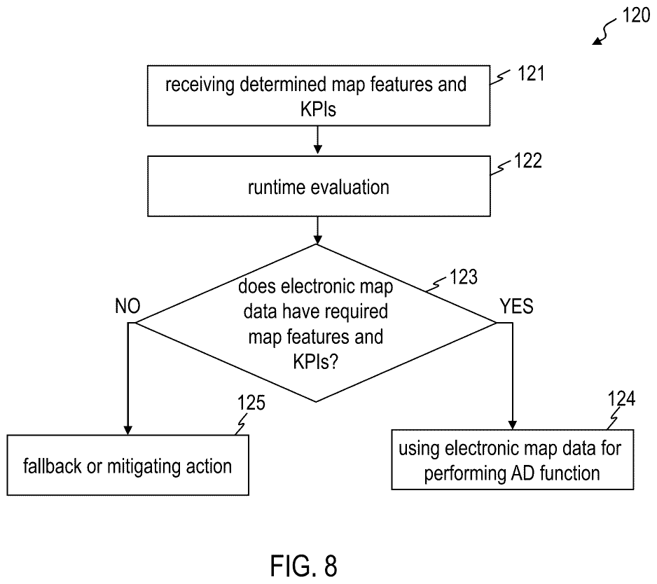

FIG. 8 is a flow chart of a method 120. The method 120 uses the determined safety-relevant map feature(s) and KPI(s) to enhance vehicle safety. The method 120 may be performed by the processing system 30 and/or the control circuit 20 of the vehicle 10 (in particular the ADS of the control circuit 20). Method 120 may be used to implement process block 63 of FIG. 3, process blocks 74, 75 of FIG. 4, or process block 86 of FIG. 5.

At process block 121, the determined safety-relevant map feature(s) and KPI(s) are retrieved. The determined safety-relevant map feature(s) and KPI(s) may specify, for each one of one or several AD functions, which map feature(s) and KPI(s) of the map feature(s) must be fulfilled by electronic map data that is used for performing the respective AD function.

At process block 122, a runtime evaluation of electronic map data may be performed onboard the vehicle 10 or by the processing system 10 or by a map or OTA server that controls the provision of map data to the vehicle 10. The evaluation at process block 122 may comprise determining which map feature(s) and KPI(s) thereof the electronic map data has. The evaluation at process block 122 may be performed based on criteria that are dependent on the received safety-relevant map feature(s) and KPI(s). This may be done as explained with reference to process blocks 72 and 73 of FIG. 4. The evaluation at process block 122 may be performed as new map data is received by the vehicle 10. The evaluation may be performed for each of the one or several AD functions, each of the associated map feature(s), and each of the associated KPI(s).

At process block 123, it is verified whether the electronic map data has the safety-relevant map feature(s) and KPI(s). This may be done as explained with reference to process blocks 72 and 73 of FIG. 4.

At process block 124, if the electronic map data has the safety-relevant map feature(s) and KPI(s), the AD function may be performed using the electronic map data. Process block 124 may comprise selectively activating the AD function in response to confirming that the electronic map data has the map feature(s) and KPI(s) specified to be safety-relevant in the received data 121.

At process block 125, a mitigating action may be performed, as previously explained.

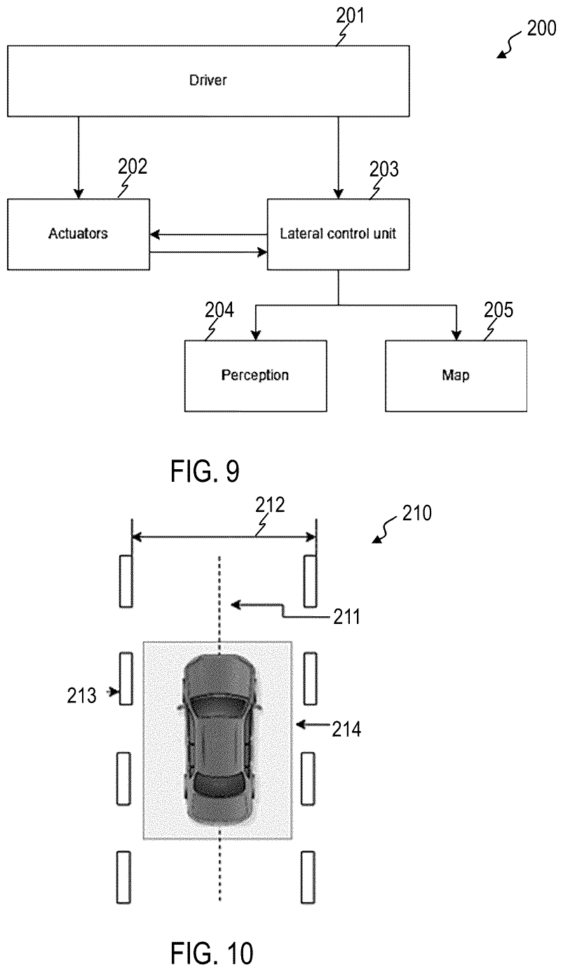

An implementation of a processing or control method will be described in greater detail with reference to an AD system that is operative to perform Adaptive Cruise control (ACC), Automatic Emergency Braking (AEB), Lane Keep Assist (LKA), and Lane Departure warning (LDW) functions. Reference will be made to FIG. 8 (already discussed above), FIG. 9, and FIG. 10.

### System Model

The system considered is a Level 3 AD system. The functions considered in this system are an Adaptive Cruise control (ACC), Automatic Emergency Braking (AEB), Lane Keep Assist (LKA), and Lane Departure warning (LDW). The AD system utilizes the lane features, traffic signs, road markings, and speed restrictions to perform its functions. The role of map feature in each AD application is discussed below. The LKA system requires the lane features to function optimally on a defined road segment.

FIG. 9 shows a high-level control structure 200 implemented by the AD system of the vehicle 10. Actuators 202 may be operated by driver action 201 or by an output of a lateral driving control unit 203. The lateral driving control unit 203 receives the actuator states as input and uses the actuator states to control the lateral position, e.g., for LKA functions.

Automated driving functions may use perception 204, i.e., the processing and interpretation of data captured by a vehicle sensor for performing the respective AD function, and electronic map data 205.

FIG. 10 shows a schematic top view 210 to explain some map features that may be used by the AD functions. Functions such as LKA and LDW may use a center line 211 of a road segment, a lane width 212, broken lane markings 213 (or the presence or absence thereof) in performing the AD functions. The purpose of LKA or LDW may be to keep a vehicle positioned within a boundary 214, which is also referred to as boundary of correctness in the art. A wandering distance sets an allowable lateral distance within which the AD vehicle can operate safely. LKA must stay within defined wandering distance, which may be, e.g., 0.375m. This distance may be defined using UNECE R157.

### Role of Map Data in LKA

Map features considered for the application of LKA are lane features. A further breakdown of lane features is possible but will not be presented in the following. Hence, the level of abstraction of map feature is limited to lane features in the following for ease of understanding. A broad set of use cases for the map data can generally be taken into consideration, reflecting different possible approaches taken by OEMs or ADS providers.

Different use cases may be considered for how the role can be used in an LKA function, as illustrated by the use cases in the following Table 1:

TABLE 1

| Use case ID | Roles of the map |
|---|---|
| UC 1 | Map data provides road geometry surrounding the vehicle |
| | (map accuracy is comparable with camera accuracy) |
| UC 2 | Map data provides road geometry for long horizons and |
| | camera providing road geometry for short horizons |
| UC 3 | Map data replaces the sensor data wherever there is no sensing possible. |
| UC 4 | Map data provides data for lane count |

### KPIs Considered

The following KPIs are considered: accuracy (positional, absolute, and relative, thematic); freshness; coverage; completeness (false positives, false negatives).

### Malfunction Identification for LKA

Malfunctions have been identified for the LKA function. A list of malfunctions obtained from IEC 61882 (HAZOP) was used in this process. The malfunctions applicable to the given AD function and its scope are summarized in the following Table 2:

TABLE 2

| Malfunction | Scope definition |
|---|---|
| Incorrect activation of LKA | In scope |
| Out of bounds LKA | In scope |
| Unstable LKA | Out of scope since we |
| | are not considering ADS |
| | design and the driver |
| | in our control |

### Vehicle Level Hazard Identification for LKA

The following hazards have been identified for an AD vehicle utilizing LKA: unintended lateral motion; unintended loss of lateral motion.

The SG(s) is/are determined from the defined vehicle level hazards. The SG for the LKA function is to ensure the vehicle stays within the bounds of the lane markings on the road. Considering this SG, the tracing of malfunctions of the AD application can be performed using an FTA. The failure to keep the vehicle within the lateral bounds can be propagated to the failure of maps. The results of the FTA are shown in FIG. 7. Malfunction identification is performed as a part of the previous step. HAZOP (IEC 61882) can be referred to ensure completeness regarding the failure modes. Instances of a map induced malfunctions obtained from HAZOP are provided in the following Table 3:

TABLE 3

| Malfunction | |
|---|---|
| ID | Malfunction description |
| FM 1 | Obsolete Lane geometry |
| FM 2 | Laterally incorrect value points/data |
| FM 3 | Incomplete lane geometry |

Correlation of Map Induced Malfunctions with the Defined Map Use Cases:

The malfunctions identified for the map data are correlated with the defined use cases of the map. This process provides the most severe malfunction for the map data. An exemplary result is provided in Table 4 below:

TABLE 4

| Malfunction ID | Relevant Use cases |
|---|---|
| FM 1 | UC 1, 2, 3, 4 |
| FM 2 | UC 1, 3 |
| FM 3 | UC 1, 3 |

From Table 4, it is noted that malfunction FM1 impacts all the use cases hence is the most severe. Following the evaluation of malfunctions with use cases, a correlation between the malfunctions and feature KPI is performed. The results are provided in Table 5 below:

TABLE 5

| Malfunction ID | Safety relevant KPI |
|---|---|
| FM 1 | Freshness |
| FM 2 | Accuracy |
| FM 3 | Completeness/Coverage |

Using Table 5, a further breakdown of the KPIs can be established by drawing a comparison with the list of KPIs considered herein. The KPIs considered herein may be as provided in the following Table 6:

TABLE 6

| Map KPI | KPI breakdown |
|---|---|
| Freshness | NA |
| Accuracy | Positional, thematic, |
| | Absolute and Relative |
| Completeness | False positives, |
| | False negatives |
| Coverage | NA |

If equal weights or priorities are assigned to each KPI estimated, since FM 1 is the most severe, the derived KPI “freshness” can be considered most critical. This is followed by malfunctions FM2 and FM3. However, a deeper look into FM2 and FM3 results in considering FM2 to be more relevant than FM3.

### Result of LKA Analysis

From the top-down analysis conducted for the function, Lane Keep Assist (LKA), the map features, lanes, is safety relevant and the following KPIs are considered as safety relevant (with the list position indicating the degree of importance): freshness; accuracy; completeness and coverage.

While a specific example has been discussed in association with LKA, similar analysis may be performed and used by the processing system to determine safety-relevant map feature(s) and safety-relevant KPI(s) for various other AD functions.

The safety-relevant map feature(s) and safety-relevant KPI(s) may be used in various ways and for various purposes, respectively in a manner which enhances vehicle safety by reducing the risk of map induced malfunctions in performance of the AD function.

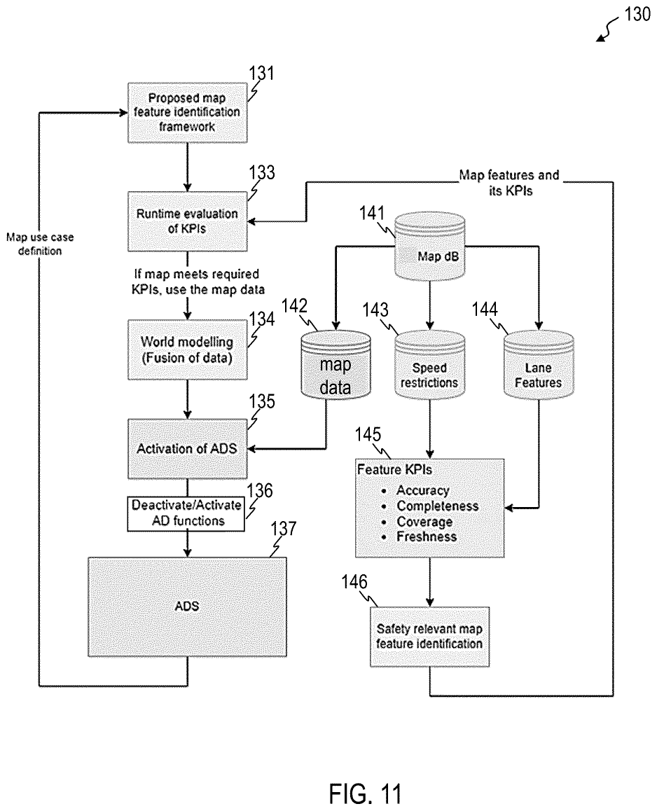

FIG. 11 illustrates a process in which a map provider maintains a map database 141. The map database may comprise one or several electronic maps. The map database 141 may define navigable segments with which speed restrictions 143 and/or lane features 144 and/or other features may be associated. Electronic map data 142 generated from the map database 141 may be provided to the vehicle 10 for use in performance of an AD function, such as an LKA function.

The map provider may determine the safety-relevant map features and KPIs 145, 146 for each of one or several AD functions. The safety-relevant map features and KPIs may be provided, in association with the AD function to which it relates, to the vehicle 10.

The vehicle control circuit 20 may optionally also be operative to perform the method disclosed herein to identify safety-relevant map feature(s) and KPI(s) for at least one AD function, as illustrated at 131.

The vehicle control circuit 20 may be operative to perform a runtime evaluation 133 of KPIs. The runtime evaluation may comprise verifying that the electronic map data has the required map features and KPI(s).

The vehicle control circuit 20 may perform a fusion 134 of perception (based on sensor data) and electronic map data to provide a world model of the vehicle surroundings. An activation 135 of an ADS may be performed onboard the vehicle. Depending on a result of the runtime evaluation 133, a selective activation or deactivation 136 of AD functions may be performed. The ADS 137 then performs the activated AD functions.

FIG. 11 uses a runtime implementation of the method implemented onboard a vehicle. This may be beneficial for a collaborative development of an ADS by multiple stakeholders (OEM, Tier 1, and map provider). The map provider is responsible for the delivery of map data along with the required meta data such as the KPIs to the vehicle 10. In addition to map data, the map provider may also provide an ODD layer which may be managed by the OEM and Tier 1.

During AD operation, the ADS can determine the usage and role of the map data depending on the vehicle functions present in the ADS. This will be used as an input to the proposed framework 131 to determine required map features. The KPIs for each map feature will be determined based on the requirements of the AD function.

The evaluation 133, which may be hosted on the ADS ECU, is performed to ensure the map delivered meets the requirements of the ADS. The evaluation may comprise a check of confidence levels assigned to different map features. If the cumulative confidence score of the map features is above the threshold defined by the ADS, the evaluation is considered successful. Successful results of the evaluation enable the world modelling process 134, fusion of map and sensor data, which is communicated to the ADS 137 if it has been activated. Failures occurring in the evaluation process cause the ADS to remain deactivated until the map data meets the required thresholds set by the ADS.

Since this techniques uses processing onboard the vehicle, it enables each OEM to define varying thresholds for the map feature KPI evaluation.

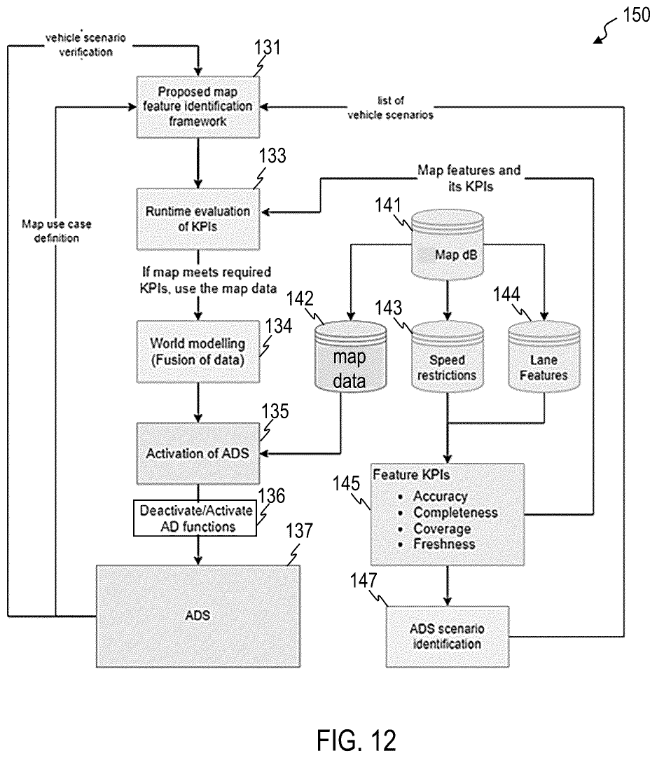

FIG. 12 illustrates operation 150 of a system which represents an extension of the techniques of FIG. 11. FIG. 12 uses a runtime implementation of the method in a vehicle.

In FIG. 12, the map providers delivers map data to the vehicle with the required metadata such as the KPIs. Based on the incoming region for which the map data has been requested, the map providers, OEMs, and/or ADS providers must determine the possible scenarios encountered by the vehicle. The scenarios can be performed by the map provider as ADS scenario identification 147 and/or onboard the vehicle, for example. The scenarios can be described as the type of maneuvers expected to be made by the ADS in the planned route for the vehicle. This will be used as an input to the map feature and KPI identification 131. The map feature and KPI identification can be performed within the vehicle using a defined machine-readable instruction code component in the ADS. The map feature and KPI identification provides a list of safety-relevant map features required for performing the selected AD function in the identified scenarios. An evaluation, which is hosted on the ADS ECU, is performed to ensure the map delivered meets the requirements of the ADS. Following the activation of the ADS, the scenarios encountered by the vehicle are logged and used for the verification of identified scenarios. The first execution of the framework requires many possible scenarios and the results obtained for them are saved by the machine-readable instruction code component of the ADS. As the ADS continues to operate in the activated state for a longer period, the list of scenarios and their required map features become more concise thereby leading to a quicker and pre-emptive executions of the method. The map features identified required for performing maneuvers which are not observed are stored in the memory cache to ensure that the framework does not have to be executed multiple times to obtain the required results. This is illustrated in FIG. 12.

Both in FIG. 11 and in FIG. 12, at least part of the method disclosed herein is implemented in the vehicle 10. Thus, embodiments also relate to a vehicle capable of performing and/or using the safety-relevant map feature(s) and KPI(s).

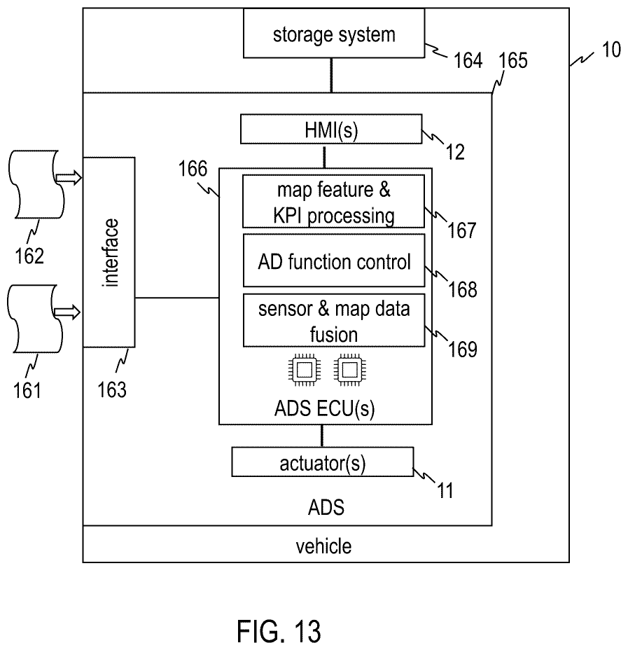

FIG. 13 is a block diagram of a vehicle 10 comprising at least one ADS ECU 166 of an ADS 165. The at least one ADS ECU 166 is operative to control one or several actuator(s) 11 and/or one or several HMI(s) 12 to perform AD functions. The ADS ECU 166 is operative to receive electronic map and sensor data 161. The electronic map data received at at least one interface 163 may be dependent on the location and driving direction of the vehicle 10. The ADS ECU 166 is operative to receive data specifying safety-relevant map feature(s) and KPI(s) 162 or to determine the safety-relevant map feature(s) and KPI(s) 162 using the techniques disclosed herein.

The at least one ADS ECU 166 may be operative to perform a map feature and KPI processing 167 to verify that electronic map data has the safety-relevant map feature(s) and KPI(s) determined for an AD function to be performed.

The at least one ADS ECU 166 may be operative to perform an AD function control 168 responsive to the processing 167. The AD function control 168 may be operative to selectively control an AD function conditionally dependent on a verification that the electronic map data has the safety-relevant map feature(s) and KPI(s).

When activated, the at least one ADS ECU 166 may perform a sensor and map data fusion 169 to generate a world model, and may control the actuator(s) 11 and/or HMI(s) based thereon.

The at least one ADS ECU 166 may comprise any one or any combination of integrated circuits, integrated semiconductor circuits, processors, controllers, application specific integrated circuits (ASICs), field programmable gate arrays (FPGAs), circuit(s) including quantum bits (qubits) and/or quantum gates, without being limited thereto.

The at least one ADS ECU 166 may be operative to store map features required for performing maneuvers which are not observed in a storage system 164 to ensure that unnecessary multiple executions of the method can be avoided.

The method disclosed herein may also be used in the initial development and/or update of AD functions. For illustration, the processing system 30 or an OTA update server may be operative to provide updates for AD functions that take into account the safety-relevant map feature(s) and KPI(s), as well as the map feature(s) and KPI(s) offered by the available electronic map data. Thus, the techniques disclosed herein may be used to control deployment and/or update of AD functions or ADSs.

Modern AD functions are being developed continually, i.e., in an ongoing manner. CI-CD pipelines may be used. Since safety engineering is dependent on the system architecture, changes in any form result in the repetition of techniques which ensure safety. To ensure that safety-by-design principles are being adhered to, the proposed method can be integrated within the development of AD functions or their updates.

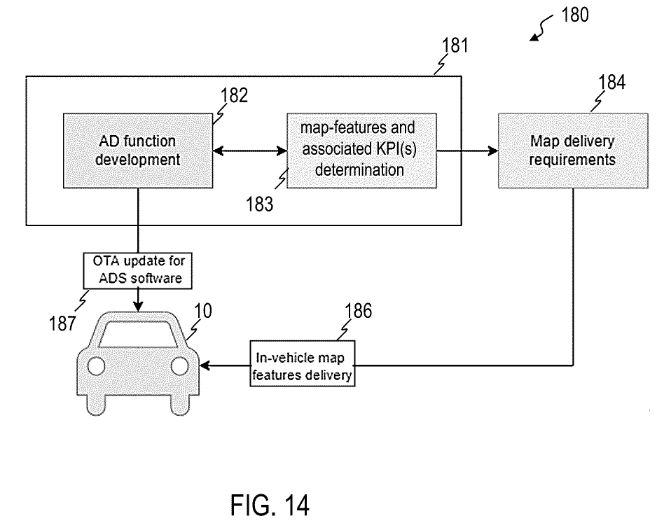

FIG. 14 illustrates such a scenario 180. If a change has been proposed to the AD function 182, the requirements on maps can change. The techniques of determining safety-relevant map features and KPI(s) 183 may be used to verify that the electronic map data provides the safety-relevant map features and KPIs for the AD function as developed or modified. By performing the method 183 during ongoing development, vehicle manufacturer or ADS manufacturer can source the required map features from map provider to ensure safe operation of their vehicles. Thereby, an enhanced AD development or AD update process 181 is provided. The results of the process 181 may be used for controlling map delivery 184 for in-vehicle map features delivery 186. The results of the process 181 may alternatively or additionally be used for performing a modification of the ADS, e.g., by means of an OTA update.

While methods, systems, and devices have been described in association with a vehicle 10, the techniques are generally applicable to a plurality of vehicles to ensure that AD functions performed by each of the plurality of vehicles use electronic map data having the safety-relevant map features and KPIs.

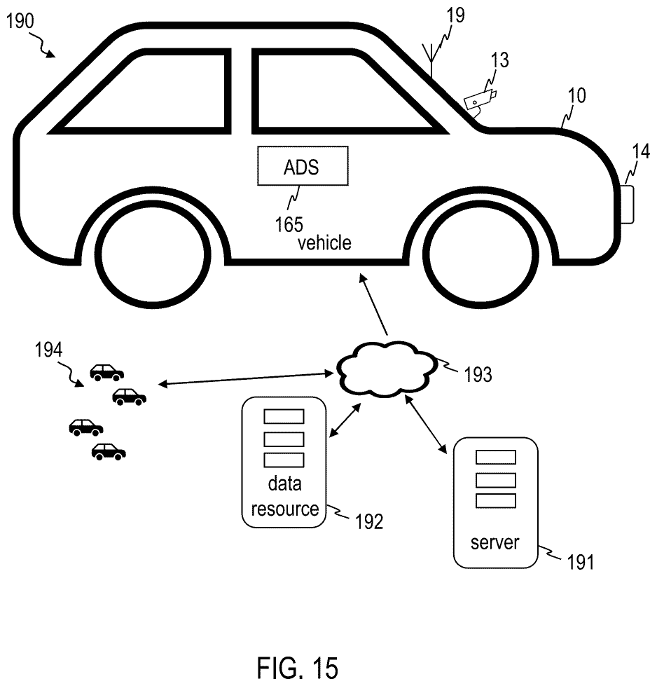

FIG. 15 shows a system 190 comprising a vehicle 10. The vehicle 10 has the ADS 165. The vehicle has an OTA interface comprising an antenna 19 for receiving electronic map data and/or ADS updates in an OTA-based manner.

The safety-relevant map feature(s) and KPI(s) may be used to control the distribution of electronic map data from a data resource 192 (such as a map server) and/or from an OTA update server 191 to the vehicle 10 as well as multiple other vehicles 194 comprised by the system 190. The distribution may be performed via a communication system 193 that may comprise a WAN and/or a cellular system.

Alternatively or additionally, the vehicle 10 and the vehicles 194 may respectively be operative to use the safety-relevant map feature(s) and KPI(s) for a runtime implementation in which the electronic map data is verified to have the safety-relevant map feature(s) and KPI(s), thereby mitigating the risk of map data induced malfunctions.

The techniques disclosed herein provided various technical effects. By determining the safety-relevant map feature(s) and KPI(s) for each of one or several AD functions and verifying electronic map data based on criteria established using the safety-relevant map feature(s) and KPI(s), the risk of map induced malfunctions is reduced. The techniques can be implemented without requiring detailed information on the logic gates that are used to implement the fusion of map data and perception (sensor data).

While embodiments have been described with reference to the drawings, modifications and alterations may be implemented in other embodiments. While exemplary use cases in which the methods and vehicle processing system can be applied have been described in detail, the techniques disclosed herein may be used in association with a variety of additional scenarios. For further illustration, while exemplary AD functions have been described, the techniques disclosed herein are generally applicable to a wide variety of AD functions at various driving automation levels.

For further illustration, while embodiments have been described in which a causality of map data for a malfunction is determined using a BN, FTA, or event tree model, other techniques such as trained ML models or multi-dimensional fits may be used to perform a causality analysis.

This description and the accompanying drawings that illustrate aspects and embodiments of the present invention should not be taken as limiting-the claims defining the protected invention. In other words, while the invention has been illustrated and described in detail in the drawings and foregoing description, such illustration and description are to be considered illustrative and not restrictive. Various mechanical, compositional, structural, electrical, and operational changes may be made without departing from the spirit and scope of this description and the claims. In some instances, well-known circuits, structures, and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

The disclosure also covers all further features shown in the Figures individually although they may not have been described in the afore or following description. Also, single alternatives of the embodiments described in the Figures and the description and single alternatives of features thereof can be disclaimed from the subject matter of the invention or from disclosed subject matter. The disclosure comprises subject matter consisting of the features defined in the claims or the embodiments as well as subject matter comprising said features.

The term “comprising” does not exclude other elements or process blocks, and the indefinite article “a” or “an” does not exclude a plurality. A single unit or process block may fulfil the functions of several features recited in the claims. The mere fact that certain measures are recited in mutually different dependent claims does not indicate that a combination of these measures cannot be used to advantage. Components described as coupled or connected may be electrically or mechanically directly coupled, or they may be indirectly coupled via one or more intermediate components. Any reference signs in the claims should not be construed as limiting the scope.

A machine-readable instruction code may be stored/distributed on a suitable medium, such as an optical storage medium or a solid-state medium supplied together with or as part of other hardware, but may also be distributed in other forms, such as via a wide area network or other wired or wireless telecommunication systems. Furthermore, a machine-readable instruction code can also be a data structure product or a signal for embodying a specific method such as the method according to embodiments.

1. A method of enhancing vehicle safety, the method comprising:
determining, by at least one processing circuit, one or several safety-relevant map features and one or several safety-relevant key performance indicators, KPIs, of at least one of the one or several safety-relevant map features for an electronic map, wherein the one or several safety-relevant map features and the one or several safety-relevant KPIs are causal for safe execution of an automated driving function by a vehicle, wherein determining the one or several safety-relevant map features and the one or several safety-relevant KPIs by the at least one processing circuit comprises:
identifying one or several map features that affect execution of the automated driving function;
determining the one or several safety-relevant map features, comprising determining which of the identified one or several map features are causal for at least one malfunction of the automated driving function;
establishing, for each of the one or several safety-relevant map features, one or several KPIs of the safety-relevant map feature causal for at least one malfunction of the automated driving function; and
determining the one or several safety-relevant KPIs for the one or several safety-relevant map features based at least on the established KPIs causal for the at least one malfunction; and
ensuring, by a server system or by the vehicle, compliance of electronic map data to be used in the execution of the automated driving function with criteria that are based at least on the one or several safety-relevant map features and the one or several safety-relevant KPIs of the one or several safety-relevant map features.

2. The method of claim 1, wherein establishing the one or several KPIs causal for at least one malfunction comprises performing a causality analysis.

3. The method of claim 2, wherein the causality analysis comprises one or both of: a fault tree analysis, a Bayesian network analysis.

4. The method of claim 2, wherein the automated driving function is performed based at least on sensor data and the electronic map data, wherein the causality analysis is performed under an assumption of fault-free sensor data.

5. The method of claim 1, wherein each of the one or several safety-relevant KPIs has an associated weight, and wherein the criteria are further based on the weight associated with at least one of the one or several safety-relevant KPIs.

6. The method of claim 1, wherein determining the one or several safety-relevant KPIs based at least on the established KPIs causal for the at least one malfunction comprises selecting the one or several safety-relevant KPIs from a pre-defined KPI set.

7. The method of claim 6, wherein the pre-defined KPI set comprises accuracy, freshness, coverage, and completeness.

8. The method of claim 1, wherein ensuring compliance of the electronic map data with criteria that are based at least on the one or several safety-relevant KPIs comprises a verification that the electronic map data have the one or several safety-relevant map features and the one or several safety-relevant KPIs.

9. The method of claim 8, further comprising selectively executing the automated driving function by the vehicle based on a result of the verification.

10. The method of claim 8, further comprising preventing execution of the automated driving function if the electronic map data does not have the one or several safety-relevant map features and preventing execution of the automated driving function if the electronic map data does not have the one or several safety-relevant KPIs.

11. The method of claim 1, further comprising determining, by the at least one processing circuit, further safety-relevant KPIs causal for safe execution of one or several further automated driving functions by the vehicle.

12. The method of claim 1, further comprising using the one or several safety-relevant map features and the one or several safety-relevant KPIs for controlling at least one of:
a modification of the electronic map to conform with the one or several safety-relevant map features and the one or several safety-relevant KPIs;
a distribution of updates of the electronic map;
activation of the automated driving function;
execution of the automated driving function.

13. A method of controlling vehicle operation, comprising:
determining one or several safety-relevant map features and one or several safety-relevant key performance indicators, KPIs, of at least one of the one or several safety-relevant map features for an electronic map, wherein the one or several safety-relevant map features and the one or several safety-relevant KPIs are causal for safe execution of an automated driving function by a vehicle, wherein determining the one or several safety-relevant map features and the one or several safety-relevant KPIs by the at least one processing circuit comprises:
identifying one or several map features that affect execution of the automated driving function;
determining the one or several safety-relevant map features, comprising determining which of the identified one or several map features are causal for at least one malfunction of the automated driving function;
establishing, for each of the one or several safety-relevant map features, one or several KPIs of the safety-relevant map feature causal for at least one malfunction of the automated driving function; and
determining the one or several safety-relevant KPIs for the one or several safety-relevant map features based at least on the established KPIs causal for the at least one malfunction;
ensuring, by a server system or by the vehicle, compliance of electronic map data to be used in the execution of the automated driving function with criteria that are based at least on the one or several safety-relevant map features and the one or several safety-relevant KPIs of the one or several safety-relevant map features; selectively activating the automated driving function in response to determining that the electronic map data has the one or several safety-relevant map features and the one or several safety-relevant KPIs; and
controlling, by the automated driving function, at least one vehicle component.

14. A processing system, comprising:
at least one processing circuit operative to determine, for the electronic map, one or several safety-relevant map features and one or several safety-relevant key performance indicators, KPIs, of at least one of the one or several safety-relevant map features, wherein the one or several safety-relevant KPIs are causal for safe execution of an automated driving function by a vehicle, wherein the at least one processing circuit is operative to perform the following operations to determine the one or several safety-relevant map features and the one or several safety-relevant KPIs:
identifying one or several map features that affect execution of the automated driving function;
determining the one or several safety-relevant map features, comprising determining which of the identified one or several map features are causal for at least one malfunction of the automated driving function;
establishing, for each of the one or several safety-relevant map features, one or several KPIs of the safety-relevant map feature causal for at least one malfunction of the automated driving function; and
determining the one or several safety-relevant KPIs for the one or several safety-relevant map features based at least on the established KPIs causal for the at least one malfunction,
wherein the processing system is operative to perform or enable a verification that electronic map data to be used in the execution of the automated driving function complies with criteria that are based at least on the one or several safety-relevant map features and the one or several safety-relevant KPIs of the one or several safety-relevant map features.

15. (canceled)

16. (canceled)

17. The method of claim 13, wherein establishing the one or several KPIs causal for at least one malfunction comprises performing a causality analysis.

18. The method of claim 17, wherein the automated driving function is performed based at least on sensor data and the electronic map data, wherein the causality analysis is performed under an assumption of fault-free sensor data.

19. The method of claim 17, wherein each of the one or several safety-relevant KPIs has an associated weight, and
wherein the criteria are further based on the weight associated with at least one of the one or several safety-relevant KPIs.

20. The method of claim 17, wherein determining the one or several safety-relevant KPIs based at least on the established KPIs causal for the at least one malfunction comprises selecting the one or several safety-relevant KPIs from a pre-defined KPI set.

21. The system of claim 14, wherein establishing the one or several KPIs causal for at least one malfunction comprises performing a causality analysis.

22. The system of claim 19, wherein the automated driving function is performed based at least on sensor data and the electronic map data, wherein the causality analysis is performed under an assumption of fault-free sensor data.
